(19) United States
(12) Patent Application Publication
(10) Pub. No.: US 2024/0011339 A1
(43) Pub. Date: Jan. 11, 2024

(54) DISPENSER AND LOCK ASSEMBLY THEREFOR

(71) Applicant: Essity Hygiene and Health Aktiebolag, Goteborg (SE)

(72) Inventors: Mark W. Henson, Harrodsburg, KY (US); Antonio Källgren, BORLÄNGE (SE)

(21) Appl. No.: 17/928,447

(22) PCT Filed: Jun. 22, 2022
(86) PCT No.: PCT/SE2020/050642

§ 371 Date: Nov. 29, 2022

(51) Int. Cl. E05C 3/30; E05B 65/00; E05C 3/00

(52) U.S. Cl. CPC E05C 3/30; E05B 65/006; E05C 3/004; A47K 2010/3246

(57) ABSTRACT

A lock assembly is provided for use with a dispenser comprising a housing having an interior volume for holding a dispensable product, the housing having an openable part for providing an access to the interior of the housing. The lock assembly comprises a lock housing, an operation mode insert portion, a lock cylinder comprising a lock cylinder base and a bore adapted to receive the operation mode insert portion, a latch connected to the lock cylinder base operable between a locked configuration and an unlocked configuration, and a resilient member biasing the latch towards the locked configuration. The operation mode insert portion is configured to form a releasable connection with the lock cylinder base and the releasable connection is accessible at the lock cylinder base to allow release of the connection and removal of the operation mode insert portion from the lock cylinder.

### CROSS REFERENCE TO RELATED APPLICATION

This application is a National Stage application of PCT/SE2020/050642, filed Jun. 22, 2020, which is incorporated by reference in its entirety herein.

### FIELD OF THE DISCLOSURE

The present disclosure relates to a dispenser with an openable part for accessing an interior of the dispenser, and a lock assembly therefor, that may be opened either with or without a key.

### BACKGROUND

Dispensers for some consumable products, such as paper towel products, liquid soap, and the like, may require access to the interior of the dispenser in order to be able to remove or refill the product periodically. Depending on where the dispenser is located, such as in a public area, it may be further required that the dispenser be locked to prevent unauthorized persons from having access to remove the entire contents of the dispenser. In this case, authorized persons will have access to a key for unlocking the dispenser. However, in other locations, such as in a private office, it may not be desirable to require the use of a key for gaining access to the interior of the dispenser to remove or refill the product.

### SUMMARY

It would be desirable to provide a dispenser with an openable part for accessing an interior of the dispenser, and a lock assembly therefor, in which the lock assembly has a simple construction.

It would also be desirable to provide a dispenser with an openable part for accessing an interior of the dispenser, and a lock assembly therefor, that may be opened either with or without a key.

A dispenser with a lock assembly that has an easily interchangeable top portion is provided. The top portion is an insert that is configured to snap-fit into the assembly and may be in the form of a push-button insert or a key-insert having a slot for receiving a key.

The disclosure provides a dispenser and a lock assembly for locking an openable part of a dispenser having an interior volume for holding a dispensable product, comprising a lock housing, an operation mode insert portion, a lock cylinder, a lock cylinder base adapted to receive the operation mode insert portion, a latch operable between a locked configuration and an unlocked configuration, and a resilient member biasing the latch toward the locked configuration. The lock housing comprises a central annular opening in which the lock cylinder is housed. The operation mode insert portion is configured to form a releasable connection with the lock cylinder base, for example a releasable snap-fit connection. The releasable connection is accessible from the lock cylinder base to allow release of the connection and removal of the operation mode insert portion from the lock cylinder.

In particular embodiments, the operation mode insert portion comprises a rounded top member having a topside and a bottomside and a longitudinal connector having first and second ends. The first end of the longitudinal connector is attached to the bottomside of the rounded top and the second end provides the snap-fit with the lock cylinder base.

In embodiments herein, the second end of the longitudinal connector comprises first and second connector arms. These connector arms are oriented parallel with each other along the length of the longitudinal connector and are spaced apart over a portion of the length by a central groove in the longitudinal connector. The first and second connector arms are configured to be biased radially inward toward the central groove in the longitudinal connector when inserted in the lock cylinder.

In embodiments herein, a free end of each of the first and second connector arms comprises a step. The step extends around a portion of a circumference of the connector arm that is opposite to the central groove. Each connector arm comprises a taper between the step and the free end.

In embodiments herein, the lock cylinder, the lock cylinder base, and the latch may be formed as a unitary component.

In embodiments herein, the operation mode insert portion may be a push-button insert.

In embodiments herein, the push-button insert and the lock cylinder are adapted to interact with each other to convert a downward movement of the insert into a rotary movement of the latch to move the latch to the unlocked configuration against the bias of the resilient member.

In embodiments herein, the push-button insert further comprises side parts that extend downwards from the top member of the operation mode insert portion. The side parts are configured to push onto sloping surfaces disposed on the circumference of the exterior of the lock cylinder.

In embodiments herein, the operation mode insert portion may be a key insert. The key insert comprises a slot adapted to receive a key.

In embodiments herein, the lock cylinder is adapted to transfer a rotary movement of the key insert and a key received therein onto the latch to move the latch to the unlocked configuration against the bias of the resilient member.

### BRIEF DESCRIPTION OF THE DRAWINGS

The present disclosure will be discussed in more detail below, with reference to the attached drawings.

FIG. 1 shows an exploded view of an embodiment of the lock assembly.

FIG. 2 shows a schematic view of an exemplary key-insert for the lock assembly.

FIG. 3 shows a schematic view of an exemplary lock cylinder base and latch of the lock assembly.

FIG. 4 shows a schematic view of an exemplary lock assembly without a housing.

FIG. 5 shows a schematic view of the bottom of an exemplary lock assembly.

FIG. 6 shows a schematic view of the lock assembly assembled together with an exemplary key-insert.

### DESCRIPTION OF PARTICULAR EMBODIMENTS

The present disclosure will refer to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure may operate in other sequences than those described or illustrated herein.

Moreover, the terms top, bottom, over, under and the like in the description and the claims are used for descriptive purposes and not necessarily for describing absolute positions. The terms so used are interchangeable under appropriate circumstances and the embodiments of the disclosure described herein may operate in orientations different from those described or illustrated herein.

Furthermore, the various embodiments, although referred to as “preferred,” are to be construed as manners in which the disclosure may be implemented by way of example rather than as limiting the scope of the disclosure.

Different aspects of the present disclosure will be described more fully hereinafter with reference to the enclosed drawings. The embodiments disclosed herein may, however, be realized in many different forms and should not be construed as being limited to the aspects set forth herein.

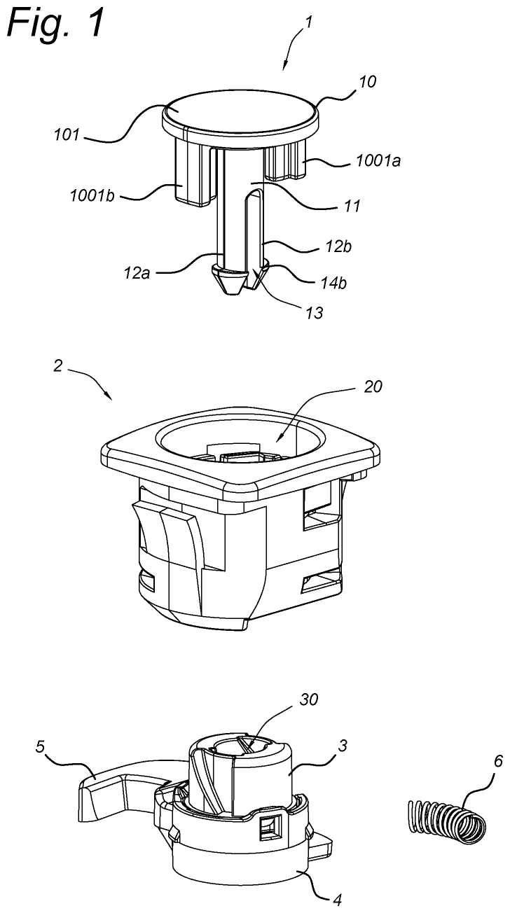

FIG. 1 is an exploded view of an embodiment of a lock assembly fora dispenser housing. The lock assembly comprises an operation mode insert portion 1, housing 2, lock cylinder 3, lock cylinder base 4, latch 5, and resilient member 6. The operation mode insert portion 1 is adapted to be inserted through a central annular opening 20 in the housing 2 and releasably snap-fit connected to the lock cylinder 3. The housing 2 is configured to enclose the lock cylinder 3 together with the operation mode insert portion 1 within the central annular opening 20. The housing may be further configured to enclose at least a portion of the lock cylinder base 4 and/or resilient member 6.

In FIG. 1 and also in FIG. 3, the lock cylinder 3, lock cylinder base 4, and latch 5 are shown as a unitary piece. The lock cylinder 3, lock cylinder base 4, and/or latch 5 may be formed together as a unitary component. Alternatively, the lock cylinder 3, lock cylinder base 4, and/or latch 5, may be formed as individual components that are subsequently assembled together. The latch 5 is configured to be attached to at least a portion of the lock cylinder base 4. The lock cylinder base 4 is further adapted such as to house at least a portion of the resilient member 6 therein so that the resilient member 6 is positioned to bias the latch 5 to a locked configuration.

The operation mode insert portion 1 shown in FIG. 1 is an example push-button insert 101. In other embodiments, the operation mode insert portion 1 is a key-insert 102. As shown in FIG. 1, the operation mode insert portion 1 comprises a top member 10 and a longitudinal connector 11. The longitudinal connector 11 has two ends, first end 110a and second end 110b.

The first end 110a is attached to a bottomside of the top member 10. The second end 110b of the longitudinal connector 11 is a free end and is configured to provide a snap-fit connection with the lock cylinder base 4. More specifically, the longitudinal connector 11 is configured to be inserted into the top of the lock cylinder 3 through a bore 30 therein and forming a snap-fit connection with the bottom of the lock cylinder 3, in particular the lock cylinder base 4.

The longitudinal connector 11 comprises, at the second end 110b, first and second connector arms 12a and 12b separated along a portion of the length of the longitudinal connector 11 by a central groove 13. As shown in FIG. 1, the first and second connector arms 12a and 12b are parallel with each other along the length of the longitudinal connector 11. The first and second connector arms 12a and 12b are configured to be biased radially inward toward the central groove 13 of the longitudinal connector 11 when the longitudinal connector 11 is inserted into the lock cylinder 3. The first and second connector arms 12a and 12b are also configured to be biased radially inward toward the central groove 13 by a user, after the longitudinal connector 11 has been inserted into and snap-fit connected together with the lock cylinder 3, for releasing the snap-fit connection and permitting removal of the operation mode insert portion 1 i.e., the push-button insert 101, from the lock cylinder 3.

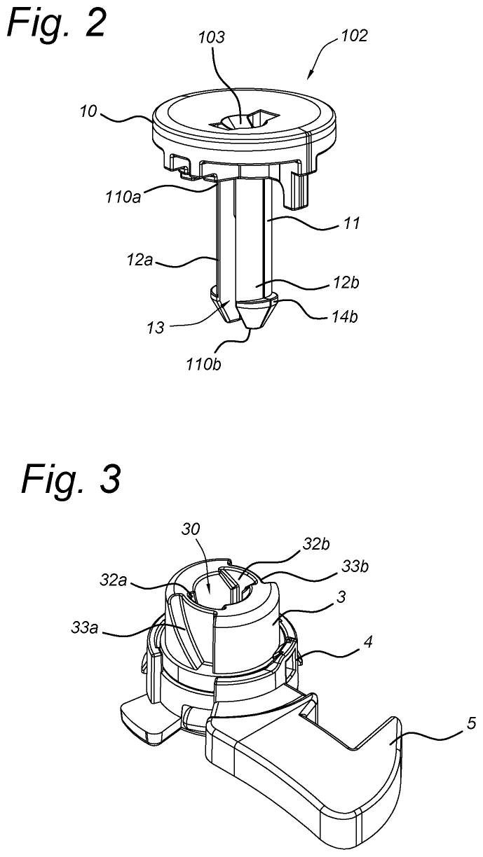

FIG. 2 shows an embodiment of an operation mode insert portion 1 that is a key insert 102. Like the push-button insert 101 shown in FIG. 1, the key insert 102 comprises a top member 10 and a longitudinal connector 11. The key insert also comprises a slot 103 into which a key (not shown) may be received for operating the latch 5 between a locked configuration and an unlocked configuration. The longitudinal connector 11 also comprises first and second connector arms 12a and 12b that run parallel with each other along the length of the longitudinal connector 11. The connector arms 12a and 12b are also separated by a central groove 13 along a portion of the length of the longitudinal connector 11. The first and second connector arms 12a and 12b are configured to be biased radially inward toward the central groove 13 of the longitudinal connector 11 when the longitudinal connector 11 is inserted into the lock cylinder 3. The first and second connector arms 12a and 12b are also configured to be biased radially biased toward the central groove 13 by a user after the longitudinal connector 11 has been inserted into and snap-fit connected together with the lock cylinder 3 for releasing the snap-fit connection and permitting removal of the key insert 102 from the lock cylinder 3.

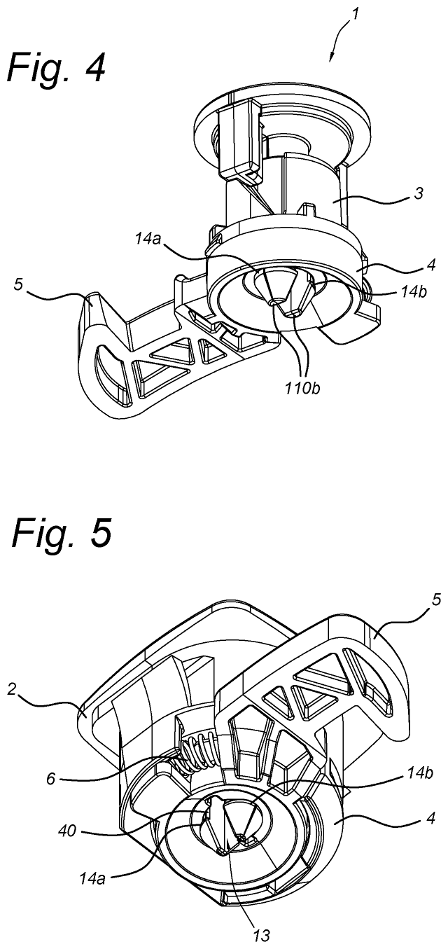

The snap-fit connection of the push-button insert 101 of FIG. 1 and the key insert 102 of FIG. 2 is carried out in the same way. At the free end 110b of the longitudinal connector 11, each of the first and second connector arms 12a and 12b comprises a respective step 14a, 14b. On each connector arm 12a and 12b, the respective step 14a, 14b is arranged to extend around a portion of the circumference of the respective connector arm 12a, 12b that is opposite to the central groove 13. As shown in FIGS. 1 and 2, the step 14a, 14b does not extend into the central groove 13. Further, each connector arm 12a and 12b comprises a tapered portion between the respective step 14a, 14b and the free end 110b. As shown in FIG. 4, the tapered portions engage at the bottom of the lock cylinder base 4, in particular with the step 14a, 14b at the bottom end of the bore 30. It is further shown that the first and second connector arms 12a and 12b are accessible to a user at the free end 110b of the longitudinal connector 11 from the bottom of the lock cylinder base 4. It may be understood from FIG. 4 that the user may simply push the tapered portions of the first and second connector arms 12a and 12b toward each other to release the snap-fit and remove the operation mode insert portion 1 from the lock cylinder 3.

In other embodiments, which are not shown, the releasable connection of the push-button insert 101 of FIG. 1 and the key insert 102 of FIG. 2 may be carried out in another way. Other types of releasable connections are considered within the scope of the present disclosure, such as for example using mechanical fixing parts such as a clip or a pin.

FIG. 3 shows a unitary component comprising the lock cylinder 3, lock cylinder base 4, and latch 5. An interior of the lock cylinder 3, through which the bore 30 passes, has first and second annular grooves 32a and 32b. The annular grooves 32a and 32b are disposed on opposite sides of an inner circumference of the lock cylinder 3 and are, in this embodiment, spaced 180° apart. The annular grooves 32a and 32b are configured to receive sides of a key (not shown) that is inserted in the assembled lock. In this way, by turning the key, the lock cylinder 3 is turned to operate the latch 5.

In an alternative embodiment (not shown), the lock cylinder 3, lock cylinder base 4, and latch 5 may be formed as individual components that are subsequently assembled together and interlocked with each other, so that the latch 5 may be operated by turning the lock cylinder 3.

When the operation mode insert portion 1 that is fitted into the lock assembly is a push-button insert 101, the push-button insert 101 and lock cylinder 3 are adapted to interact together to convert a downward movement of the insert 101 i.e., a pushing force on the push-button insert 101, into a rotary movement of the latch 5 to move the latch 5 to the unlocked configuration against the bias of the resilient member 6. This is achieved by side parts 1001a, 1001b of the push-button insert 101, which extend downward from the top member 10 of the operation mode insert portion 1. The side parts 1001a, 1001b are configured to push onto respective sloping surfaces 33a and 33b disposed on the circumference of the exterior of the lock cylinder 3 (see FIG. 4).

When the operation mode insert portion 1 that is fitted into the lock assembly is a key insert 102, the lock cylinder 3 is adapted to transfer a rotary movement of the key insert 102 and a key received therein onto the latch 5 to move the latch 5 to the unlocked configuration against the bias of the resilient member 6.

An example operation mode insert portion 1, lock cylinder 3, lock cylinder base 4, and latch 5 are shown assembled in FIG. 4. The housing 2 that surrounds the operation mode insert portion 1, lock cylinder 3, and at least a portion of the lock cylinder base 4 has been removed in FIG. 4. Here, the operation mode insert portion 1 has been inserted through the bore 30 of the lock cylinder 3 and connected therewith, with the lock cylinder 3 being attached to the lock cylinder base 4. The free end 110b of the longitudinal connector 11 may be seen from the bottom of the lock cylinder base 4. In this regard, the free end 110b is accessible to enable a user to release the operation mode insert portion 1 from the lock cylinder 3. The operation mode insert portion 1 is releasable from the lock cylinder by radially biasing the first and second connector arms 12a and 12b inward toward the central groove 13 so that the respective steps 14a, 14b on each of the first and second connector arms 12a and 12b are permitted to clear the lower ring 31 on the lock cylinder 3 and reversely pass back through the bore 30.

FIG. 5 shows a bottom view of an embodiment of the lock assembly. The first and second connector arms 12a and 12b are shown to be snap-fit connected to the lock cylinder 3, in particular the lock cylinder base 4. The respective steps 14a, 14b on each of the first and second connector arms 12a and 12b are shown to be prohibited from being translated upwardly back through the lock cylinder 3 by a central annular opening 40 in the lock cylinder base 4. The longitudinal connector 11, however, may be removed from the lock cylinder 3 and lock cylinder base 4 by radially biasing the first and second connector arms 12a and 12b inwardly toward the central groove 13 so that the steps 14a, 14b are permitted to clear the inner ridge 41 of the central annular opening 40.

A resilient member 6 may be at least partially housed between the housing 2 and the lock cylinder base 4. In some embodiments the resilient member 6 may be completely enclosed within the housing 2 and/or the lock cylinder base 4. Alternatively, the resilient member 6 may be partially exposed from the housing 2 and/or the lock cylinder base 4. The resilient member 6 is operable to bias the latch 5 in a locked configuration with respect to the lock cylinder base 4.

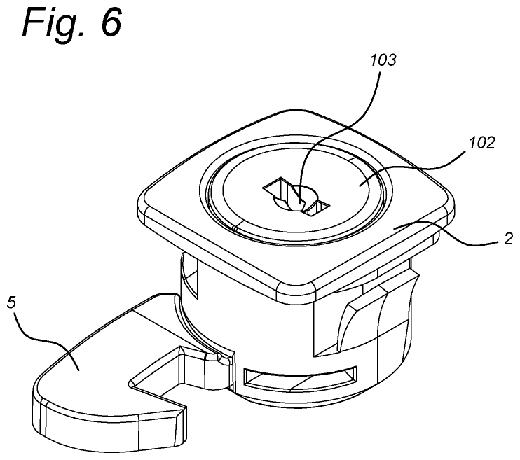

FIG. 6 is a schematic view of an assembled embodiment of the lock assembly. The operation mode insert portion 1 is a key insert 102, which is fit into and enclosed by housing 2. The key insert 102 is interfit with the lock cylinder 3 (not shown) in the central annular opening 20 of the housing 2. The lock cylinder is rotatably connected with the lock cylinder base 4, a small portion of which may be observed below the housing 2. The latch 5, which may be controlled between a locked configuration and unlocked configuration by operation of a key received in the key insert 10, may be positioned to extend transversely from the lock cylinder base 4.

It is foreseen that the embodiments described herein may be used in combination with and/or for use in a dispenser, and more particularly a dispenser comprising a dispenser housing having an interior volume adapted for holding a dispensable product, such as, but not limited to, paper towel products, soaps, paper tissues, and the like. It is further envisioned that such dispensers have an openable portion to provide access to the interior such that the dispensable product may be refilled and/or removed periodically, either in part or in its entirety.

It is to be understood that the disclosure herein is not limited to the embodiments described above but may be varied within scope as consistent with the spirit of the disclosure.

1. A dispenser comprising a dispenser housing having an interior volume for holding a dispensable product, the housing having an openable part to provide access to the interior volume for refilling the dispensable product, and a lock assembly for locking the openable part, the lock assembly comprising:
a lock housing comprising a central annular opening,
an operation mode insert portion,
a lock cylinder, housed in the central annular opening, comprising a lock cylinder base, the lock cylinder comprising a bore that is adapted to receive the operation mode insert portion,
a latch connected to the lock cylinder base, the latch being operable between a locked configuration and an unlocked configuration, and
a resilient member biasing the latch with towards the locked configuration,
wherein the operation mode insert portion is configured to form a releasable connection with the lock cylinder base, and
wherein the releasable connection is accessible at the lock cylinder base to allow release of the connection and removal of the operation mode insert portion from the lock cylinder.

2. The dispenser according to claim 1, wherein the operation mode insert portion comprises a rounded top member having a topside and a bottom_side and a longitudinal connector having first and second ends, wherein the first end of the longitudinal connector is attached to the bottom_side of the rounded top and the second end provides the snap-fit with the lock cylinder base.

3. The dispenser according to claim 2, wherein the second end of the longitudinal connector comprises first and second connector arms that are parallel with each other along the length of the longitudinal connector and are spaced apart over a portion of the length of by a central groove in the longitudinal connector, and wherein the first and second connector arms are configured to be radially biased inward toward the central groove in the longitudinal connector when inserted in the lock cylinder.

4. The dispenser according to claim 3, wherein a free end of each of the first and second connector arms comprises a step, the step extending around a portion of a circumference of the connector arm that is opposite to the central groove, and the where each connector arm comprises a taper between the step and the free end.

5. The dispenser according to claim 3, wherein an interior of the lock cylinder comprises first and second annular grooves disposed on opposite sides of the lock cylinder and wherein the first and second annular grooves are configured to correspond to and receive the first and second connector arms, respectively.

6. The dispenser according to claim 5, wherein the first and second annular grooves are spaced 180° apart.

7. The dispenser according to claim 1, wherein the lock cylinder, lock cylinder base and latch are formed as a unitary component.

8. The dispenser according to claim 1, wherein the operation mode insert portion is a push-button insert.

9. The dispenser according to claim 8, wherein the push-button insert and the lock cylinder are adapted to interact with each other to convert a downward movement of the insert into a rotary movement of the latch to move the latch to the unlocked configuration against the bias of the resilient member.

10. The dispenser according to claim 9, wherein the push-button insert further comprises side parts that extend downwards from the top member, the side parts being configured to push onto sloping surfaces on an outer circumference of the lock cylinder.

11. The dispenser according to claim 1, wherein the operation mode insert portion is a key insert, the key insert comprising a slot adapted to receive a key.

12. The dispenser according to claim 11, wherein the lock cylinder is adapted to transfer a rotary movement of the key insert and a key received therein onto the latch to move the latch to the unlocked configuration against the bias of the resilient member.

13. The dispenser according to claim 1, wherein the releasable connection is a releasable snap-fit connection.

14. A lock assembly for use with a dispenser according to claim 1.
